(19) United States
(12) Patent Application Publication
(10) Pub. No.: US 2011/0277856 A1
(43) Pub. Date: Nov. 17, 2011

(54) VALVE FOR REGULATING WATER QUANTITY

(75) Inventor: In-Tak Lee, Busan (KR)

(73) Assignee: WOONGJIN COWAY CO., LTD., Choongcheongnam-do (KR)

(21) Appl. No.: 13/145,907

(22) PCT Filed: Feb. 26, 2010
(86) PCT No.: PCT/KR2010/001230

§ 371 Date: Jul. 22, 2011

(30) Foreign Application Priority Data
Feb. 26, 2009 (KR) 10-2009-0016460
Jul. 7, 2009 (KR) 10-2009-0061623

(51) Int. Cl. F16K 15/00

(52) U.S. Cl. 137/511

(57) ABSTRACT

There is provided a valve for regulating water quantity capable of regulating a flow rate so as to maintain a constant recovery ratio even if raw water is supplied with a variety of pressure levels within a wide pressure range, and of preventing the blockage of a flow passage caused by foreign substances. The valve for regulating water quantity includes a body including therein a flow channel allowing a fluid to flow, a guide member installed in the body and guiding an introduced fluid, the guide member including a tapered cavity such that a flow rate of a fluid passing therein is regulated, and a flow-rate regulation unit installed in the body and slid according to pressure of a fluid, introduced to the body, so as to be moved into or out of the tapered cavity, the flow-rate regulation unit regulating a discharge flow rate. Accordingly, the flow rate can be regulated by varying the cross-section of a fluid flow passage using a flow-rate regulation member, so that a constant discharge flow rate can be maintained even if the pressure of a fluid, introduced to the body, is varied. Furthermore, foreign substances, when caught in the fluid flow passage, can be easily removed from the fluid flow passage by using the flow-rate regulation member which is slidable, and this can prevent the backflow of the fluid.

### TECHNICAL FIELD

The present invention relates to a valve for regulating water quantity, and more particularly, to a valve for regulating water quantity, which is used for a reverse osmosis water purifier to control the amount of living water being discharged.

### BACKGROUND ART

Due to growing water pollution problems, water purifiers capable of purifying contaminated water are drawing attention. Such water purifiers use water purification methods such as a reverse osmosis method, a hollow fiber membrane method, and a natural filtering method.

When an osmotic membrane (semi-permeable membrane) is installed between water having a high concentration of ions, molecules or the like and water having a low concentration thereof, water moves from an area of low concentration to an area of high concentration due to the osmosis effect. Finally, the concentrations of both areas of water become balanced. The pressure of the water in this balanced state is referred to as osmotic pressure.

When pressure higher than the osmotic pressure is applied in an opposite direction to the direction of osmotic pressure, water passes through the osmotic membrane. At this time, elements other than water are separated from the water to a desired extent, so that the water can be purified. This method is called the reverse osmosis method.

A water purifier employing the reverse osmosis method (i.e., a reverse osmosis water purifier) is typically provided with a reverse osmosis membrane filter. The reverse osmosis membrane filter is connected with a discharge line in order to discharge concentrate water, inevitably generated during a reverse osmosis process.

A discharge valve is provided on the discharge line. The discharge valve serves to delay the flow of concentrate water being discharged, and has a recovery ratio, which is generally determined to be in the range of about 20% to 30% in consideration of the contamination level of the reverse osmosis membrane filter.

Here, the recovery ratio is determined by the following equation:

Recovery ratio=Purified water quantity/(Purified water quantity+Concentrate water quantity)×100

The reverse osmosis water purifier includes a pressure device, such as a pressure pump, in order to apply pressure, higher than the osmotic pressure, to the reverse osmosis membrane filter.

However, of late, the reverse osmosis water purifier has often been designed without a pressure device such as a pressure pump for the purpose of cost reduction. In this case, a discharge value according to the related art is unable to precisely regulate the recovery ratio of raw water supplied with a wide pressure range. Namely, the related art discharge valve fails to regulate a flow rate sufficient to achieve the recovery ratio of 20% to 30%.

### DISCLOSURE OF INVENTION

### Technical Problem

An aspect of the present invention provides a valve for regulating water quantity, which can regulate a flow rate so as to achieve a predetermined recovery ratio even when raw water is supplied with a variety of pressure levels within a wide pressure range.

An aspect of the present invention also provides a valve for regulating water quantity, which can prevent a flow passage from being blocked by foreign substances.

### Solution to Problem

According to an aspect of the present invention, there is provided a valve for regulating water quantity, the valve including: a body including therein a flow channel allowing a fluid to flow; a guide member installed in the body and guiding an introduced fluid, the guide member including a tapered cavity such that a flow rate of a fluid passing therein is regulated; and a flow-rate regulation unit installed in the body, and slid according to pressure of a fluid, introduced to the body, so as to be moved into or out of the tapered cavity, the flow-rate regulation unit regulating a discharge flow rate.

The tapered cavity may include a flow-passage groove providing a fluid flow passage when one end of the flow-rate regulation unit is inserted and disposed in the tapered cavity.

The flow-rate regulation unit may include: a flow-rate regulation member slid according to the pressure of the fluid introduced to the body; and an elastic member mounted on the flow-rate regulation member and applying pressure to the flow-rate regulation member.

The guide member may include a flow-passage hole communicating with the tapered cavity such that the fluid is introduced to the tapered cavity.

The body may include an installation cavity in which the guide member and the flow-rate regulation member are mounted.

The body may have a linear shape.

The flow-rate regulation unit may include: a flow-rate regulation member including a through hole allowing a fluid to pass therethrough, and slid according to pressure of a fluid flowing into the body; and an elastic member mounted on the flow-rate regulation member to pressurize the flow-rate regulation member, wherein the through hole is an orifice having a stepped portion to be pressurized by a fluid flowing into the body.

The body may include an installation cavity in which the guide member and the flow-rate regulation member are mounted, the installation cavity being provided with a guide portion guiding a path of the flow-rate regulation member being slid.

The body may include a first flow path portion disposed in a rear portion of the installation cavity and regulating a flow rate of a fluid being discharged, wherein the first flow path is an orifice.

The guide member may include a second flow path portion communicating with the tapered cavity and introducing a fluid into the tapered cavity, wherein the second flow path portion is an orifice regulating a flow rate of a fluid passing therein.

### Advantageous Effects of Invention

According to the present invention, a flow rate can be regulated by varying the cross-section of a fluid flow passage using a flow-rate regulation member, so that a constant discharge flow rate can be maintained, even if the pressure of a fluid, introduced to a body, is varied.

Furthermore, foreign substances, when caught in a fluid flow passage, can be easily removed from the fluid flow passage by using the flow-rate regulation member which is slidable. This can prevent the backflow of the fluid.

### BRIEF DESCRIPTION OF DRAWINGS

FIG. 1 is a view illustrating a location at which a valve for regulating water quantity is installed, according to an exemplary embodiment of the present invention.

FIG. 2 is a cross-sectional view illustrating a valve for regulating water quantity according to an exemplary embodiment of the present invention.

FIG. 3 is a perspective view illustrating a guide member according to an exemplary embodiment of the present invention.

FIG. 4 is a view for describing the operation of a valve for regulating water quantity according to an exemplary embodiment of the present invention.

FIG. 5 is a view for describing the operation of a valve for regulating water quantity according to an exemplary embodiment of the present invention.

FIG. 6 is a view for describing the operation of a valve for regulating water quantity according to an exemplary embodiment of the present invention.

FIG. 7 is a cross-sectional view illustrating a valve for regulating water quantity according to another exemplary embodiment of the present invention.

FIG. 8 is a view for describing the operation of a value for regulating water quantity according to another exemplary embodiment of the present invention.

FIG. 9 is a view for describing the operation of a valve for regulating water quantity according to another exemplary embodiment of the present invention.

FIG. 10 is a view for describing the operation of a valve for regulating water quantity according to another exemplary embodiment of the present invention.

### MODE FOR THE INVENTION

Hereinafter, a valve for regulating water quantity according to an exemplary embodiment of the present invention will now be described with reference to the accompanying drawings.

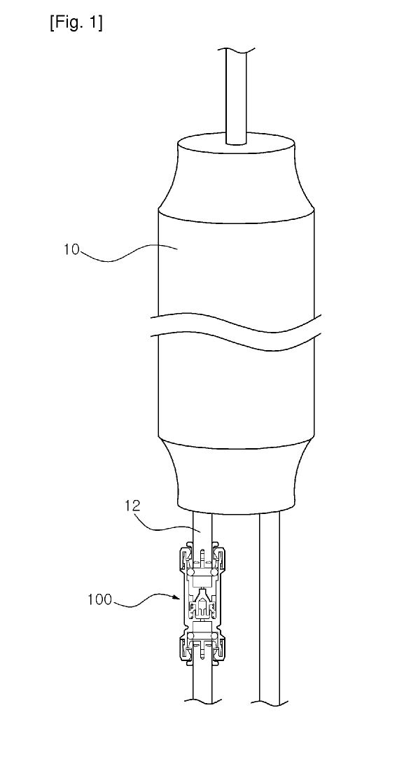

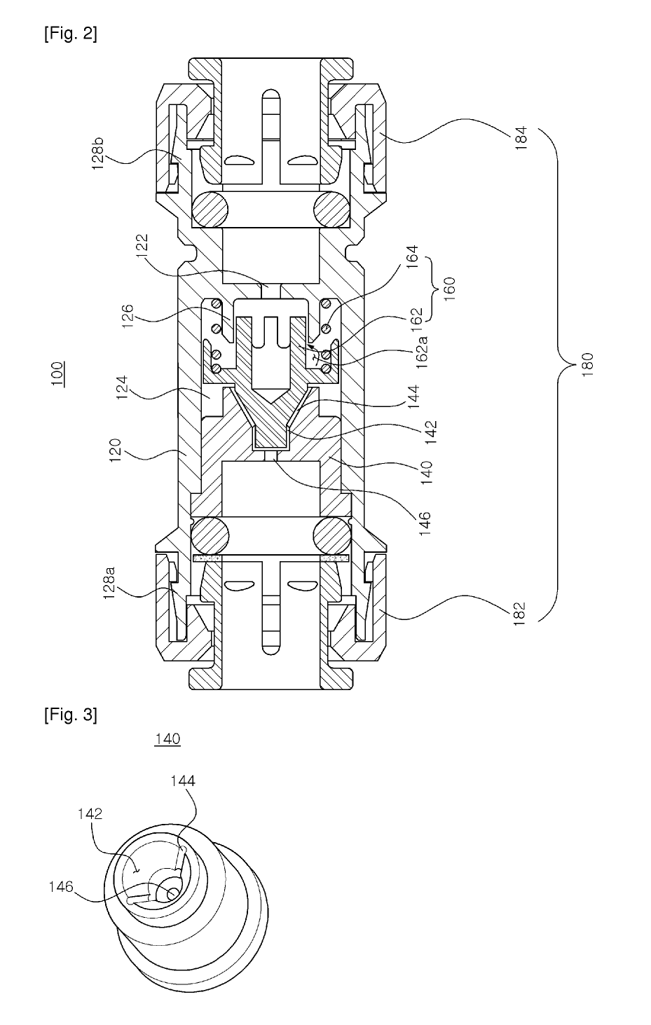

FIG. 1 is a view showing a location at which a valve for regulating water quantity is installed, according to an exemplary embodiment of the present invention, and FIG. 2 is a cross-sectional view illustrating a valve for regulating water quantity according to an exemplary embodiment of the present invention.

Referring to FIGS. 1 and 2, a valve 100 for regulating water quantity (hereinafter “water quantity regulation valve”) is connected to, for example, a discharge tube 12 of a membrane filter 10, and serves to regulate the amount of living water discharged from the membrane filter 10 (hereinafter “flow rate”).

As shown in FIG. 2, the water quantity regulation valve 100 includes a body 120, a guide member 140, a flow-rate regulation unit 160, and a connection member 180.

The body 120 may include therein a flow channel 122 allowing a fluid to flow. The body 120 provides a flow passage connected with the flow channel 122 and through which a fluid flows, and may include an installation cavity 124 in which the guide member 140 and the flow-rate regulation unit 160 are installed.

The installation cavity 124 may be provided with a guide portion 126 guiding a flow passage when the flow-rate regulation unit 160 is slid and moved.

The body 120 may include first and second mounting portions 128a and 128b at both ends. The connection member 180 for a connection with a tube (not shown) in which a fluid flows is mounted on these first and second mounting portions 128a and 128b. For example, a part of the connection member 180, connected with an inflow tube (not shown) introducing a fluid to the body 120, may be mounted on the first mounting portion 128a, while another part of the connection member 180, connected with an outlet tube (not shown) discharging a fluid from the body 120, may be mounted on the second mounting portion 128b.

Although the body 120 has a linear shape in this embodiment, the shape thereof is not limited to that of the illustration.

The guide member 140 is installed inside the body 120 and guides an introduced fluid, and may include a tapered cavity 142 such that the flow rate of a fluid passing therein can be regulated. That is, the amount of fluids passing through the guide member 140 is regulated according to an extent to which one end of the flow-rate regulation unit 160 is inserted into the tapered cavity 142.

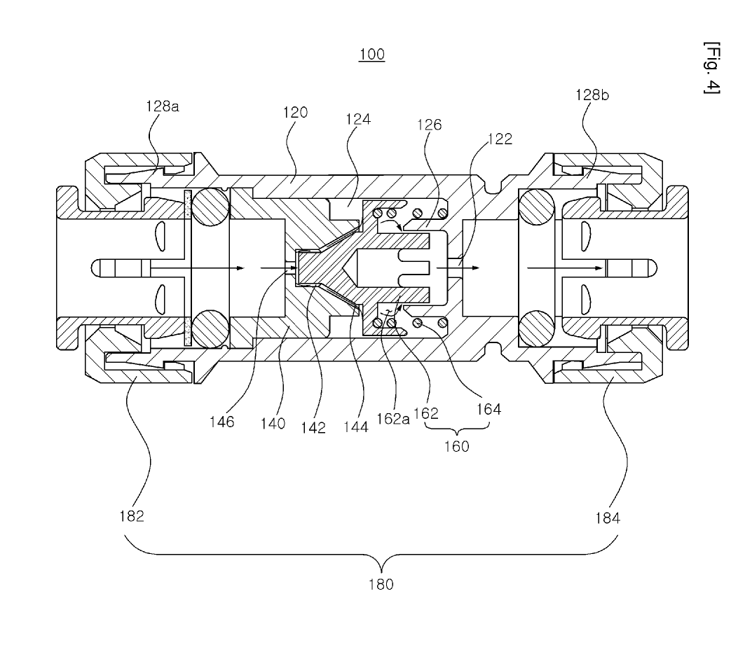

As shown in FIG. 3, the tapered cavity 142 may include a flow-passage groove 144 that provides a fluid flow passage when one end of the flow-rate regulation unit 160 is inserted in the tapered cavity 142. Namely, as one end of the flow-rate regulation unit 160 is inserted and disposed in the tapered cavity 142, a fluid may flow through only the flow-passage groove 144.

Further, the guide member 140 may include a flow-passage hole 146 communicating with the tapered cavity 142 such that a fluid is introduced to the tapered cavity 142. Accordingly, a fluid, introduced to one side of the body 120 (the left side on FIG. 2), may flow into the tapered cavity 142 through the flow-passage hole 146, and then flow into the installation cavity 124 of the body 120.

The flow-rate regulation unit 160, installed in the body 120, is slid according to the pressure of the fluid, introduced to the body 120, so as to be moved into or out of the tapered cavity 142. In this manner, the flow rate of the fluid being discharged (i.e., a discharge flow rate) can be regulated.

To this end, the flow-rate regulation unit 160 may include a flow-rate regulation member 162 and an elastic member 164.

The flow-rate regulation member 162 may be installed inside the installation cavity 124 of the body 120 such that it can be slid according to the pressure of a fluid introduced to the body 120. One end of the flow-rate regulation member 162 may have the same shape as the tapered cavity 142 in order to be inserted in the tapered cavity 142.

The flow-rate regulation member 162 may have a coupling cavity 162a such that one end of the elastic member 164 is inserted and coupled thereto.

Further, the other end of the flow-rate regulation member 162 is disposed inside the guide portion 126 provided in the installation cavity 124. Thus, the flow-rate regulation member 162 can be slid along the guide portion 126.

Namely, the flow-rate regulation member 162 is disposed so as to be completely inserted into the tapered cavity 142 when a fluid having a low pressure level is introduced to the body 120. At this time, the fluid, introduced to the body 120, flows through the flow-passage groove 144 of the guide member 140, and then flows into the installation cavity 124.

Also, when a fluid having a high pressure level is introduced to the body 120, the flow-rate regulation member 162 is slid such that one end thereof is separated from the tapered cavity 142. Here, the flow-rate regulation member 162 may be slid by the guide of the guide portion 126.

In this case, the area of the fluid flow passage is increased to thereby increase the flow rate therein. In such a manner, the discharge flow rate is regulated.

When one end of the flow-rate regulation member 162 is inserted in the tapered cavity 142, and thus a fluid flows through only the flow-passage groove 144, foreign substances, caught in the flow-passage groove 144, increase the pressure applied to the flow-rate regulation member 162. Thus, the flow-rate regulation member 162 is slid such that one end thereof is separated from the tapered cavity 142, thereby increasing the area of the fluid flow passage.

In this case, the foreign substances, caught in the flow-passage groove 144, may be moved by the fluid and thus be removed from the flow-passage groove 144. When the foreign substances are removed from the flow-passage groove 144, the flow-rate regulation member 162 is slid so as to be inserted into the tapered cavity 142.

The elastic member 164 may be mounted on the flow-rate regulation member 162 so as to apply pressure to the flow-rate regulation member 162. Namely, the elastic member 164 is installed inside the installation cavity 124, and has one end inserted and supported in the coupling cavity 162a of the flow-rate regulation member 162, and the other end supported by one side surface of the installation cavity 124 of the body 120.

Accordingly, the flow-rate regulation member 162 is pressed by the elastic member 164, thereby becoming slidable according to the pressure of a fluid introduced to the body 120.

The connection member 180 may be connected with a tube (not shown) coupled to the body 120 and in which a fluid flows. To this end, the connection member 180 may include a first connection member 182 and a second connection member 184.

The first connection member 182 is mounted on the first mounting portion 128a, and may be connected with, for example, an inlet tube (not shown) receiving a fluid and introducing it to the body 120. The second connection member 184 is mounted on the second mounting portion 128b, and may be connected with an outlet tube (not shown) in which a fluid discharged from the body 120 flows.

The connection member 180 is constructed such that a tube in which a fluid flows, as in a hose, is inserted and coupled thereto. This is a well-known construction to those skilled in the art, and thus a detailed description thereof is omitted.

Furthermore, an O-ring that serves to prevent a fluid from leaking to the outside may be installed in the body 120.

As described above, the cross section of the fluid flow passage is varied by the flow-rate regulation member 162, thereby regulating the flow rate. Accordingly, a constant discharge flow rate can be maintained even if the pressure of an introduced fluid is varied.

Furthermore, foreign substances, when caught in a fluid flow passage, namely, the flow-passage groove 144, can be easily removed by using the slidable flow-rate regulation member 162. This can contribute to preventing the backflow of an introduced fluid.

Hereinafter, the operation of the water quantity regulation valve, according to an exemplary embodiment of the present invention, will be described with reference to the accompanying drawings.

FIGS. 4 through 6 are views for describing the operation of the water quantity regulation valve according to an exemplary embodiment of the present invention.

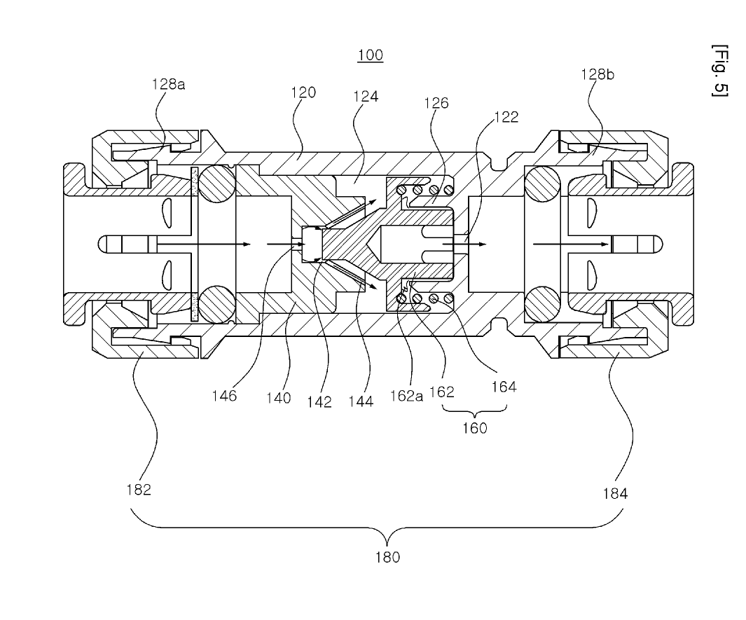

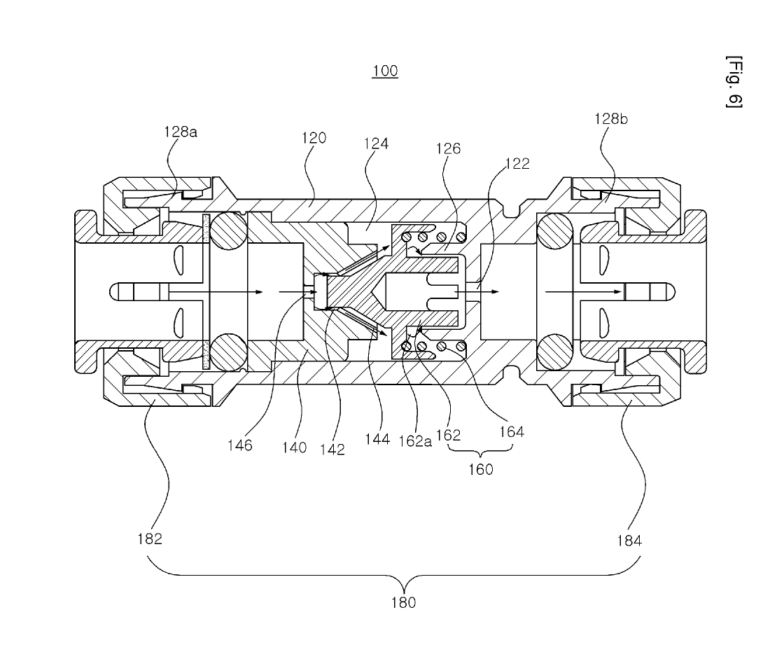

In detail, FIG. 4 is an operational view showing the water quantity regulation valve when a fluid having a low pressure level flows into the body. FIG. 5 is an operational view showing the water quantity regulation valve when a fluid having a high pressure level is introduced to the body. FIG. 6 is an operational view illustrating the water quantity regulation valve when a fluid having a medium pressure level between the high pressure level and the low pressure level flows into the body.

Referring to FIG. 4, a fluid, having a low pressure level between 2 kg/cm² to 4 kg/cm² for example, flows into the body 120. At this time, the force applied on the flow-rate regulation member 162 by the introduced fluid is smaller than that applied on the flow-rate regulation member 162 by the elastic member 164.

Accordingly, one end of the flow-rate regulation member 162 stays inserted in the tapered cavity 142 of the guide member 140, and thus the fluid introduced to the body 120 flows into the installation cavity 124 through only the flow-passage groove 144.

That is, when a fluid with low hydraulic pressure is introduced to the body 120, the flow-rate regulation member 162 reduces the cross-section of the fluid flow passage, thereby decreasing the discharge flow rate of the fluid.

Referring to FIG. 5, a fluid, having a high pressure level between 8 kg/cm² to 10 kg/cm² for example, flows into the body 120. At this time, the force applied to the flow-rate regulation member 162 by the introduced fluid is greater than that applied to the flow-rate regulation member 162 by the elastic member 164.

Accordingly, the flow-rate regulation member 162 is slid such that one end thereof is spaced apart from the tapered cavity 142. This increases the cross-section of the fluid flow passage, thereby increasing the flow rate of the fluid flowing into the installation cavity 124.

Thereafter, as the pressure of the introduced fluid is lowered, the force applied on the flow-rate regulation member 162 by the fluid becomes smaller than the force applied thereon by the elastic member 164. In this case, the flow-rate regulation member 162 is slid by the recovery force applied by the elastic member 164 such that one end of the flow-rate regulation member 162 is inserted in the tapered cavity 142.

Referring to FIG. 6, when a fluid having a medium pressure level, for example, a pressure level between 5 kg/cm² and 7 kg/cm², is introduced to the body 120, the flow-rate regulation member 162 is slid by the introduced fluid.

In this case, the extent to which the flow-rate regulation member 162 is slid is smaller than when the fluid with a high pressure level is introduced. That is, one end of the flow-rate regulation member 162 is disposed adjacent to the tapered cavity 142 but does not make contact with the tapered cavity 142.

Accordingly, the cross-section of the fluid flow passage is greater than when a fluid with a low pressure level is introduced, while being smaller than when a fluid with a high pressure level is introduced. Accordingly, the flow rate of the fluid introduced to the installation cavity 124 and discharged outside the body 120 may range between a flow rate when the fluid with a low pressure level is introduced and a flow rate when the fluid with a high pressure level is introduced.

Meanwhile, when a fluid with a low pressure level is introduced and thus flows to the installation cavity 124 through only the flow-passage groove 144 as in the state depicted in FIG. 4, foreign substances may be caught in the flow-passage groove 144.

In this case, the foreign substances block the flow of a fluid into the installation cavity 124 through the flow-passage groove 144. This increases pressure applied to the fluid. Accordingly, the flow-rate regulation member 162 is slid so as to increase the cross-section of the fluid flow passage.

Consequently, the fluid flows trough the widened fluid flow passage and the foreign substances caught in the flow-passage groove 144 can be removed from the flow-passage groove 144 by the flowing fluid. Thus, the backflow of the fluid, caused by the foreign substances, can be prevented.

Hereinafter, a valve for regulating water quantity (i.e., a water quantity regulation valve) according to another exemplary embodiment of the present invention will be described with reference to accompanying drawings.

FIG. 7 is a cross-sectional view illustrating a water quantity regulation valve according to another exemplary embodiment of the present invention.

The water quantity regulation valve 200 may be a valve that is connected to a membrane filter (not shown) and serves to regulate the amount of living water discharged from the membrane filter (hereinafter “flow rate”).

Referring to FIG. 7, the water quantity regulation valve 200 includes, for example, a body 220, a guide member 240, a flow-rate regulation unit 260, and a connection member 280.

The body 220 has a linear, cylindrical shape so that a fluid can flow thereinto. Further, the body 220 may have an installation cavity 224 in which the guide member 240 and the flow-rate regulation unit 260 are installed.

A guide portion 226 may be provided in the installation cavity 224. When the flow-rate regulation unit 260 is slid, the guide portion 226 guides the path thereof.

Since the body 220 has a linear shape, components (i.e., the guide member 240, the flow-rate regulation unit 260 and the like) installed inside the body 220 can be simplified as compared to a water quantity regulation valve having a bent shape. Thus, a reduction in the size of the water quantity regulation valve can be achieved.

That is, the water quantity regulation valve 200 is installed typically in a small space due to a plurality of pipes. However, the body 220, having a linear shape, allows for the miniaturization of the water quantity regulation valve, a limitation in installation space can be reduced.

Further, the body 220 may have a first flow path portion 222 in the rear end of the installation cavity 224. The first flow path portion 222 serves to regulate the quantity of fluid. The first flow path portion 222 may be an orifice.

The body 220 may include first and second mounting portions 228a and 228b at both ends, respectively. The connection member 280 for a connection with a pipe (not shown) in which a fluid flows is mounted on these first and second mounting portions 228a and 228b. For example, a part of the connection member 280, connected with an inlet pipe (not shown) introducing a fluid to the body 220, may be mounted on the first mounting portion 228a, while another part of the connection member 280, connected with an outlet pipe (not shown) discharging a fluid from the body 220, may be mounted on the second mounting portion 228b.

The guide member 240 is installed inside the body 220 and guides an introduced fluid, and may include a tapered cavity 242 such that the flow rate of a fluid passing therethrough can be regulated. The tapered cavity 242 may be provided in one edge portion of the guide member 240 such that the quantity of fluid discharged through the tapered cavity 242 can be regulated as the flow-rate regulation unit 260 is moved in and out.

That is, the amount of fluid passing through the guide member 240 is regulated according to an extent to which one end of the flow-rate regulation unit 260 is inserted into the tapered cavity 242.

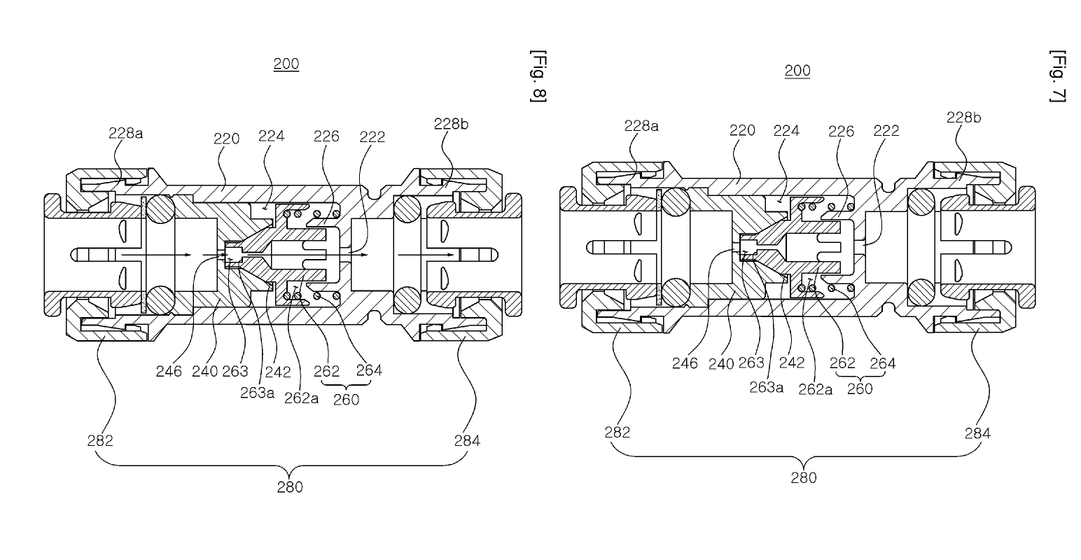

The guide member 240 may have a second flow path portion 244 communicating with the tapered cavity 242 such that a fluid flows into the tapered cavity 242. Thus, a fluid, introduced into one side of the body 220 (the left side on FIG. 8), can flow into the tapered cavity 242 through the second flow path portion 246, and then flow into the installation cavity 224 of the body 220.

The second flow path portion 246 may be an orifice in order to regulate the flow rate of a fluid passing therethrough.

The flow-rate regulation unit 260 is mounted in the body 220 such that the flow-rate regulation unit 260 is moved in and out of the tapered cavity 242 as it is slid according to the pressure of a fluid flowing into the body 220. The flow-rate regulation unit 260 may include a through hole 263 through which a fluid passes into the flow-rate regulation unit 260.

The flow-rate regulation unit 260 may include, for example, a flow-rate regulation member 262 and an elastic member 264.

The flow-rate regulation member 262 may be installed in the installation cavity 224 of the body 220 and is slidable according to the pressure of a fluid introduced to the body 220. One end of the flow-rate regulation member 262 may have the same shape as the tapered cavity 242 such that it can be inserted thereinto.

The through hole 263 is formed in the flow-rate regulation member 262 such that a fluid flows inside. The through hole 263 may have a stepped portion 263a so as to be pressurized by a fluid flowing thereinto and thus cause the flow-rate regulation member 262 to slide.

That is, the flow-rate regulation member 262 may be slid as the stepped portion 263a is pressurized by a fluid flowing into the through hole 263. The through hole 263 may be an orifice that includes the stepped portion 263a and can regulate the flow rate of a fluid.

In addition, the flow-rate regulation member 262 may include a coupling recess 262a in which one end of the elastic member 264 is inserted and coupled.

The other end of the flow-rate regulation member 262 is disposed inside the guide portion 226 provided in the installation cavity 224, so that the flow-rate regulation member 262 can be slid along the guide portion 226.

That is, the flow-rate regulation member 262 is disposed such that one end of the flow-rate regulation member 262 is fully inserted into the tapered cavity 242 when the pressure of a fluid flowing into the body 220 is low. In this case, the fluid flowing into the body 220 flows through only the through hole 263 of the flow-rate regulation member 262 and enters the first flow path portion 222 provided in the rear end of the installation cavity 224.

Also, when the pressure of a fluid flowing into the body 220 is high, the flow-rate regulation member 262 is slid to have its one end of the flow-rate regulation member 262 spaced apart from the tapered cavity 242. At this time, the flow-rate regulation member 262 can be slid under the guide of the guide portion 226.

In this case, the area of a fluid flow passage (i.e., a fluid flow area) increases. In detail, a fluid can flow through the through hole 263 of the flow-rate regulation member 262 and the tapered cavity 242 of the guide member 240 and then enter the first flow path portion 222 of the body 220. The flow rate therein increases accordingly, so that the flow rate of a fluid being discharged (i.e., a discharge flow rate) can be regulated.

The elastic member 264 may be mounted around the flow-rate regulation member 262 to pressurize the flow-rate regulation member 262. In detail, the elastic member 264 is installed in the installation cavity 224 such that one end of the elastic member 264 is inserted into and supported by the coupling recess 262a of the flow-rate regulation member 262, while the other end thereof is supported by one side surface of the installation cavity 224.

Thus, the flow-rate regulation member 262 is pressurized by the elastic member 264 and can thus be slid according to the pressure of a fluid introduced to the body 220. That is, when the pressure of a fluid flowing into the body 220 increases, the elastic member 264 is compressed and supports the flow-rate regulation member 262. Thereafter, as the pressure of a fluid flowing into the body 220 decreases, the elastic member 264 is extended to thereby insert one end of the flow-rate regulation member 262 into the tapered cavity 242.

The connection member 280 may be coupled with the body 220 and connected with a pipe (not shown) through which a fluid flows. To this end, the connection member 280 may include the first connection member 282 and the second connection member 284.

The first connection member 282 is mounted on the first mounting portion 228a, and may be connected to, for example, an inlet pipe (not shown) through which a fluid is supplied to the body 220. The second connection member 284 is mounted on the second mounting portion 228b, and may be connected to, for example, an outlet pipe (not shown) through which a fluid discharged from the body 220 flows.

The connection member 280 is a construction in which a pipe such as a hose in which a fluid flows is inserted and coupled thereto. This construction is well-known to those skilled in the art, and a detailed description will be omitted.

In addition, an O-ring may be installed in the body 220 in order to prevent the undesired outflow of a fluid.

As described above, a flow rate can be regulated by varying a fluid flow area using the flow-rate regulation member 262. Thus, a discharge flow rate can be constantly maintained, even if the pressure of a fluid being introduced varies.

Furthermore, the flow rate of a passing fluid can be regulated by the second flow path portion 246 provided in the guide member 240, the first flow path portion 222 provided in the body and the through hole 263 provided in the flow-path regulation member 262. Thus, a discharge flow rate can be constantly maintained. Namely, the discharge flow rate can be easily regulated, since the flow rate of a fluid can be regulated as it passes through the flow path portions 222 and 246 and the through hole 263, which are three orifices.

Hereinafter, the operation of a water quantity regulation valve, according to another exemplary embodiment of the present invention, will be described with reference to the accompanying drawings.

FIGS. 8 through 10 are views for describing the operation of the water quantity regulation valve according to another exemplary embodiment of the present invention.

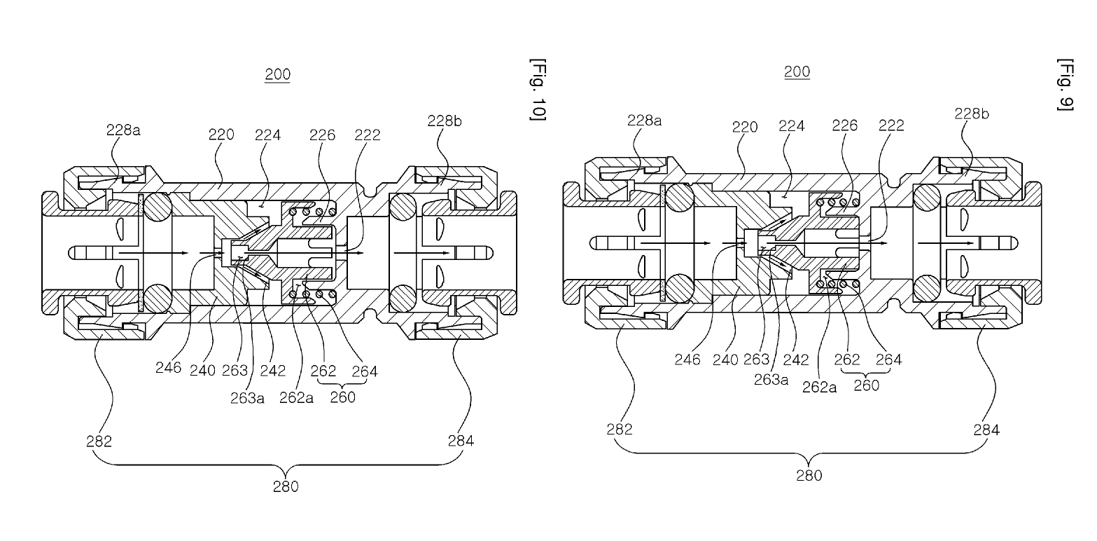

In detail, FIG. 8 is an operational view illustrating the operation of the water quantity regulation valve when a fluid having a low pressure level flows into the body. FIG. 9 is an operational view illustrating the operation of the water quantity regulation valve when a fluid having a high pressure level flows into the body. FIG. 10 is a view illustrating the operation of the water quantity regulation valve when a fluid having a medium pressure level between the high and low pressure levels flows into the body.

Referring to FIG. 8, a fluid, having a low pressure level between 2 kg/cm² and 4 kg/cm² for example, flows into the body 120. At this time, the force applied to the flow-rate regulation member 262 by the introduced fluid is smaller than that applied to the flow-rate regulation member 262 by the elastic member 264.

Accordingly, one end of the flow-rate regulation member 262 is inserted in the tapered cavity 242 of the guide member 240, and thus the fluid introduced to the body 220 flows into the installation cavity 224 through only the through hole 263 of the flow-rate regulation member 262.

That is, when a fluid having a low pressure level flows into the body 220, the flow-rate regulation member 262 is inserted into the tapered cavity 242 so that the fluid flows through only the through hole 263 of the flow-rate regulation member 262. A fluid flow area in this state is smaller than a fluid flow area in a state where the flow-rate regulation member 262 is separated from the tapered cavity 242.

That is, when a fluid with a low pressure level flows into the body 220, the flow rate of a fluid discharged from the body 220 becomes smaller than when a fluid with a high pressure level flows into the body 220.

Referring to FIG. 9, when a fluid having a pressure level higher than a predetermined pressure level, between 8 kg/cm² and 10 kg/cm² for example, is introduced, the force applied to the flow-rate regulation member 262 by the pressure of the introduced fluid becomes greater than the force applied to the flow-rate regulation member 262 by the elastic member 264.

Accordingly, the flow-rate regulation member 262 is slid so that one end of the flow-rate regulation member 262 is spaced apart from the tapered cavity 242. Consequently, a fluid flow area increases, thereby increasing the flow rate of a fluid flowing into the installation cavity 224. That is, the fluid flows through the through hole 263 of the flow-rate regulation member 262, and the tapered cavity 242 of the guide member 240. Thus, the flow rate of a fluid introduced to the installation cavity 224 is increased.

Thereafter, when the pressure of a fluid being introduced decreases, the force applied on the flow-rate regulation member 262 by the flow becomes smaller than the force applied thereon by the elastic member 264. In this case, the flow-rate regulation member 262 is slid by a restoring force applied to the elastic member 264 so as to have its one end inserted into the tapered cavity 242.

Referring to FIG. 10, when a fluid having a medium pressure level, for example, a pressure level between 5 kg/cm² and 7 kg/cm², is introduced to the body 220, the flow-rate regulation member 262 is slid by the introduced fluid.

In this case, the extent to which the flow-rate regulation member 262 is slid is smaller than when the fluid with a high pressure level is introduced. That is, one end of the flow-rate regulation member 262 is disposed adjacent to the tapered cavity 242 but does not make contact with the tapered cavity 242.

Accordingly, the fluid flow area is greater than when a fluid with a low pressure level is introduced, while still being smaller than when a fluid with a high pressure level is introduced. Accordingly, the flow rate of a fluid discharged outside the body 220 after flowing into the installation cavity 224 may range between a flow rate when the fluid with a low pressure level is introduced and a flow rate when the fluid with a high pressure level is introduced.

1. A valve for regulating water quantity, the valve comprising:
a body including therein a flow channel allowing a fluid to flow;
a guide member installed in the body and guiding an introduced fluid, the guide member including a tapered cavity such that a flow rate of a fluid passing therein is regulated; and
a flow-rate regulation unit installed in the body and slid according to pressure of a fluid, introduced to the body, so as to be moved into or out of the tapered cavity, the flow-rate regulation unit regulating a discharge flow rate.

2. The valve of claim 1, wherein the tapered cavity includes a flow-passage groove providing a fluid flow passage when one end of the flow-rate regulation unit is inserted and disposed in the tapered cavity.

3. The valve of claim 1, wherein the flow-rate regulation unit includes:
a flow-rate regulation member slid according to the pressure of the fluid introduced to the body; and
an elastic member mounted on the flow-rate regulation member and applying pressure to the flow-rate regulation member.

4. The valve of claim 1, wherein the guide member includes a flow-passage hole communicating with the tapered cavity such that the fluid is introduced to the tapered cavity.

5. The valve of claim 1, wherein the body includes an installation cavity in which the guide member and the flow-rate regulation member are mounted.

6. The valve of claim 1, wherein the body has a linear shape.

7. The valve of claim 1, wherein the flow-rate regulation unit includes;
a flow-rate regulation member including a through hole allowing a fluid to pass therethrough, and slid according to pressure of a fluid flowing into the body; and
an elastic member mounted on the flow-rate regulation member to pressurize the flow-rate regulation member,
wherein the through hole is an orifice having a stepped portion to be pressurized by a fluid flowing into the body.

8. The valve of claim 7, wherein the body includes an installation cavity in which the guide member and the flow-rate regulation member are mounted, the installation cavity being provided with a guide portion guiding a path of the flow-rate regulation member being slid.

9. The valve of claim 8, wherein the body includes a first flow path portion disposed in a rear portion of the installation cavity and regulating a flow rate of a fluid being discharged,
wherein the first flow path is an orifice.

10. The valve of claim 1, wherein the guide member includes a second flow path portion communicating with the tapered cavity and introducing a fluid into the tapered cavity,
wherein the second flow path portion is an orifice regulating a flow rate of a fluid passing therethrough.
